(19) United States
(12) Patent Application Publication
(10) Pub. No.: US 2002/0183872 A1
(43) Pub. Date: Dec. 5, 2002

(54) Golf site administration system

(75) Inventors: Kazuhisa Matsumoto, Hyogo (JP); Koji Morimoto, Hyogo (JP); Takehiko Takimoto, Hyogo (JP); Toshihiko Ogaki, Hyogo (JP); Kazuhiro Matsuoka, Hyogo (JP); Tomoaki Uenishi, Hyogo (JP); Ichiro Yamakawa, Kyoto (JP); Masaru Hattori, Shiga (JP)

Correspondence Address: DARBY & DARBY P.C., Post Office Box 5257, New York, NY, 10150-5257, US

(73) Assignee: Sanyo Electric Co., Ltd.

(21) Appl. No.: 10/159,103

(22) Filed: May 29, 2002

(30) Foreign Application Priority Data
May 31, 2001 (JP) 2001-165575

(51) Int. Cl. G06F 155/00

(52) U.S. Cl. 700/91

(57) ABSTRACT

A golf site administration system allows elimination of golf site personnel involved in making player reservations, receiving payments, and ordering foodstuffs. A terminal allows a player to request and reserve golf play at a golf site via a communication circuit. A reservation signal is stored in a reservation storing means. The player checks in before play using an input means. A set of check-in information is compared with the stored reservation signal. If the information matches, check-in is performed.

### BACKGROUND OF THE INVENTION

1. Field of the Invention

The present invention relates to a golf site administration system that manages various types of data used in a golf site.

2. Discussion of the Related Art

Japanese Patent Publication Number: 2001-46575 (A63B 69/36) discloses a conventional golf site administration system. The invention issues a management card to a player during registration. The issuing of locker keys, sales of products, and the ordering of food are performed based on this management card, eliminating the need for the player to carry cash. With this system, an automated accounting device settles accounts when play is finished and retrieves the management card that was issued.

In this system, however, a player must use a conventional method such as calling by telephone to register for play, and accounts are settled via conventional processing such as issuing an invoice to a credit card company. Furthermore, golf site employees must be provided to perform administrative tasks such as ordering food and goods. As a result, personnel relating to golf play by players can be eliminated, but personnel for administrative tasks cannot.

### OBJECTS AND SUMMARY OF THE INVENTION

It is an object of the present invention to overcome the foregoing and various other drawbacks of the prior art by providing a golf site administration system that permits reduction in personnel involved in player reservations, accounting, ordering of food, and goods.

The present invention relates to an input/output means connected via a communication circuit to a terminal for requesting golf play and a reservation storing means that stores a play request signal received by the input/output means. The input means allows a player to check in before play and a control circuit compares an input signal of the input means with the request signal stored in the reservation storing means. The control circuit performs the check-in when the signals match and indicates information on a reporting means if the signals do not match.

The claimed invention allows the player to make play reservations to input/output means at the golf site via a communication circuit using a terminal. At the golf site, this information is stored in a reservation storing means when the reservation is made. When the player checks in on the reservation date, the player's information can be checked to see if it is the player who made the reservation. If the data matches, the check-in is performed. Otherwise, a message is indicated using a reporting means.

Another embodiment of the invention includes an input means for checking in a golf player, before play, using a credit card and receiving the credit card for payment of fees within the golf site. An accounting data storing means stores the input signal of the input means and a control circuit reads the data stored in the accounting data storing means at a predetermined time and sends the data to a credit card company via a communication circuit.

In this embodiment, the player checks in before play using a credit card. When making payment in the golf site, this credit card is used. The accounting data is stored in an accounting data storing means. An invoice is communicated to the credit card company at a predetermined time via a communication circuit.

Another embodiment includes a food selecting means that allows a golf player to enter a food order. Then the foodstuff data storing means stores the data ordered with the food selecting means. Next, a control circuit sends the foodstuff data from the foodstuff data storing means to a foodstuff company at a predetermined time via a communication circuit. Thus, each time a player orders food, this data is stored in foodstuff storing means and at a predetermined interval, this foodstuff data is used to make orders via the communication circuit.

A further embodiment included a food selecting means to receive input when the player requests play and the control circuit may send that information from the foodstuff data storing means to the foodstuff company via the communication circuit at a predetermined time before play. Alternatively, the golf site can have predetermined meals ready, with additional meals being ordered based on orders from players.

Additional embodiments include when a play request signal is received by the input/output means, information from the golf site is sent to the terminal via the communication circuit. Also, a score storing means may store a score of the player on the golf site and information sent to the terminal from the golf site is a score of the player.

All of the above embodiments may include a “thank-you” message or the like or scores from previous games can be sent to players after the request is completed. Additionally, services, advertisements, and promotions can also be provided to the player. Information may be sent from the golf site to the terminal at a predetermined time after a play completed signal is received by the input means.

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

### BRIEF DESCRIPTION OF THE DRAWINGS

FIG. 1 is a block diagram of a system according to an embodiment of the present invention;

FIG. 2 is a block diagram of a golf site system according to the present invention;

FIG. 3 is a sample schedule data list according to the present invention;

FIG. 4 is a sample accounting data list according to the present invention;

FIG. 5 is a sample foodstuff data list according to the present invention;

FIG. 6 is a sample score storing means list according to the present invention;

FIG. 7 is a sample address storing means list according to the present invention;

FIG. 8 illustrated an input screen on a terminal of the present invention;

FIG. 9 is a display screen sent to a terminal of the present invention;

FIG. 10 is a flowchart illustrating the check-in operations of the present invention; and

FIG. 11 is a display screen shown on a terminal in the system.

### DETAILED DESCRIPTION OF THE PREFERRED EMBODIMENTS

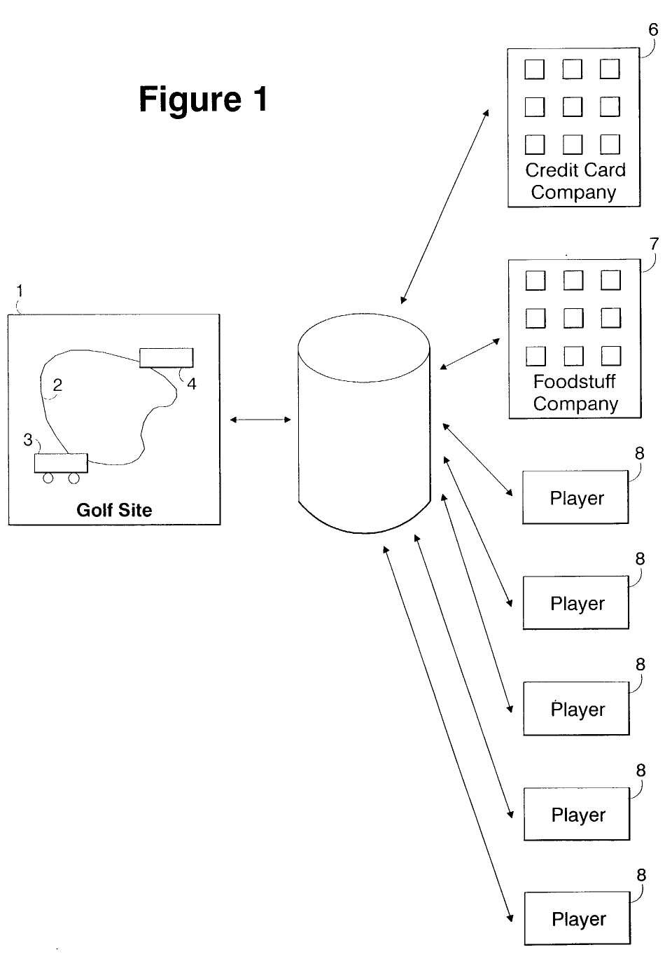

Referring to now FIG. 1, an overview of the embodiments of a golf site administration system according to the present invention will be described. A golf site 1 includes a guide wire 2 embedded along a golf course. A plurality of golf carts 3 run along the guide wire 2, where the golf carts 3 are used to transport players' golf bags.

A club house 4 is positioned at the starting point of the golf course on the golf site 1. The club house 4 may include a restaurant, an office used for managing the golf site 1, and a master room used to manage play time and the golf carts 3. A host computer 5 is a host computer of a provider or the like that is connected to the golf site 1 via a communication circuit such as a phone line, optical cable, radio link or satellite.

A credit card company 6 may receive invoice data from the credit card transactions. The data is received through a communication circuit from the golf site 1 via the host computer 5. The credit card company 6 may also send various types of information to the golf site 1 via a communication circuit.

A foodstuff company 7 receives food orders from the golf site 1 via a communication circuit. The foodstuff company 7 can also send various types of information such as new product guides and menus back to the golf site 1.

A terminal 8 is a personal computer, personal digital assistant (PDA), cellular phone or the like owned by a player. Terminal 8 allows players to perform registration for the golf site 1 via a communication circuit such as the Internet.

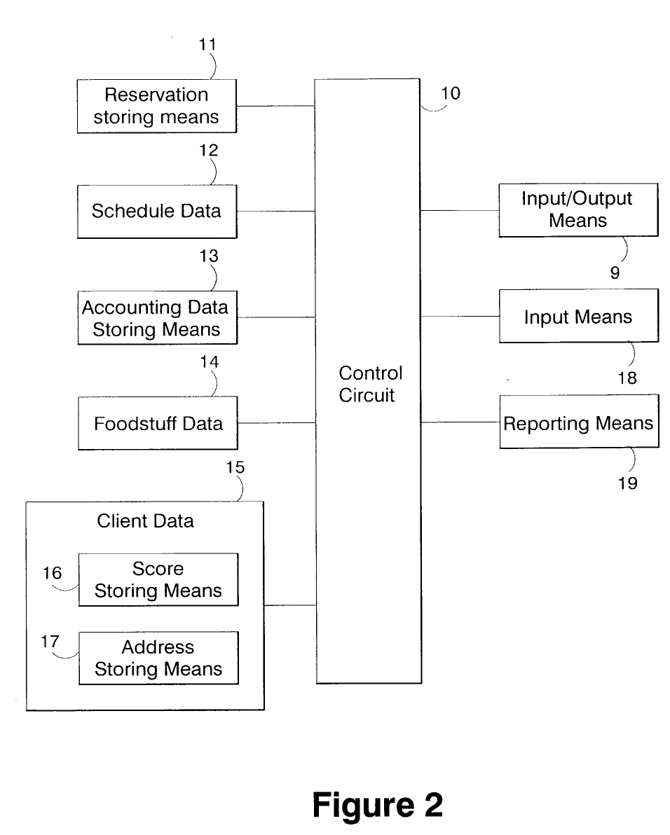

Referring now to FIG. 2, a control operation used to perform administrative tasks in the club house 4 includes an input/output means 9 used to connect to the credit card company 6, the foodstuff company 7, the terminal 8, and the golf site 1 via a communication circuit. The input/output means 9 may output invoice information to the credit card company 6, order information to the foodstuff company 7, and reservation information to the terminal 8. Input/output means 9 also receives various information from the credit card company 6, promotional information from the foodstuff company 7, and reservation request information from the terminal 8. All received information is sent to a control circuit 10 and stored.

As play reservation information is received from the input/output means 9, a reservation storing means 11 receives the data from the control circuit 10. The reservation storing means 11 may store the credit card number, the PIN number, name, address, and other personal identifying or transactional information of the player making a reservation.

Information stored in reservation storing means 11 is then transferred to a schedule data 12 after a predetermined number of days have elapsed. The schedule data 12 stores a list of player data organized by day, time, or player skill.

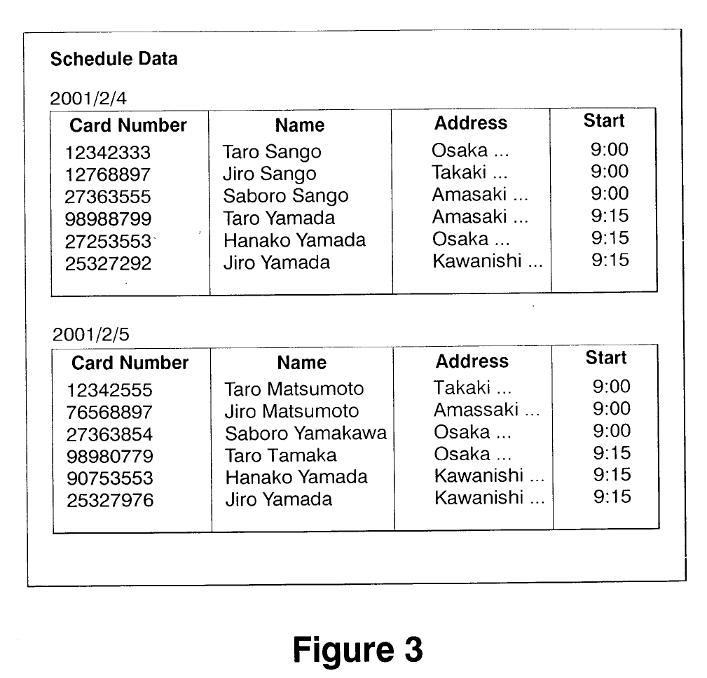

Referring to FIG. 3, one embodiment of the schedule data 12 stores a table for each day that contains the players' card numbers, names, addresses, and start times. This information is received based on the reservation data received by the input/output means 9. An accounting data storing means 13 stores card numbers and fees when a player makes payment using a credit card. Accounting data storing means 13 accesses this data on predetermined days for invoicing to the credit card company 6 and sends the accounting data to the credit card company 6.

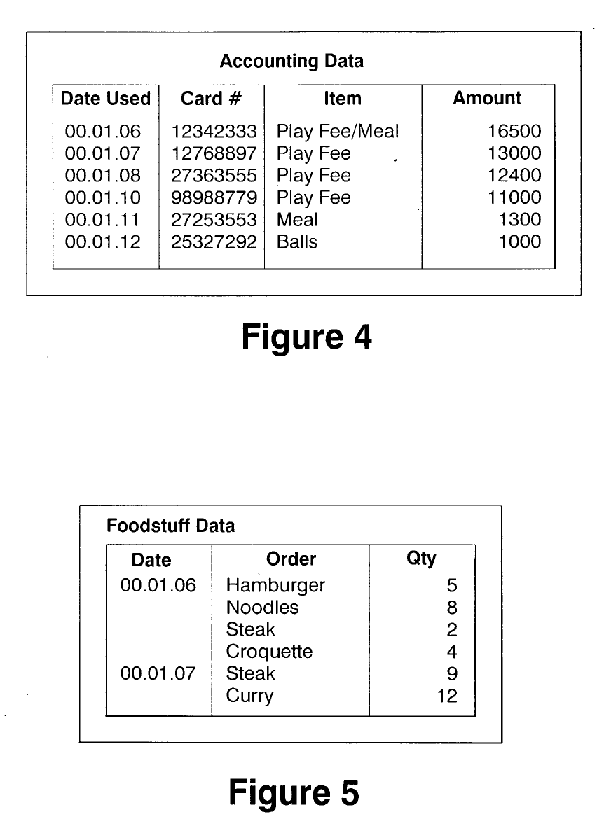

Referring to FIG. 4, the accounting data storing means 13 stores the accounting data received from the input/output means 18, and stores, for example, the credit card usage date, the card number, the item charged, and the amount.

Foodstuff data storage means 14 provides temporary storage of order information to be sent to the foodstuff company 7. The foodstuff data storage means 14 transmits order data to the foodstuff company 7 each time food is to be ordered. Information is stored in the foodstuff data storage means 14 when a player makes a reservation using the terminal 8 or when play starts, at which point the menu that was ordered is stored. FIG. 5 illustrates a sample foodstuff data containing the serving date, the item ordered, and the quantity.

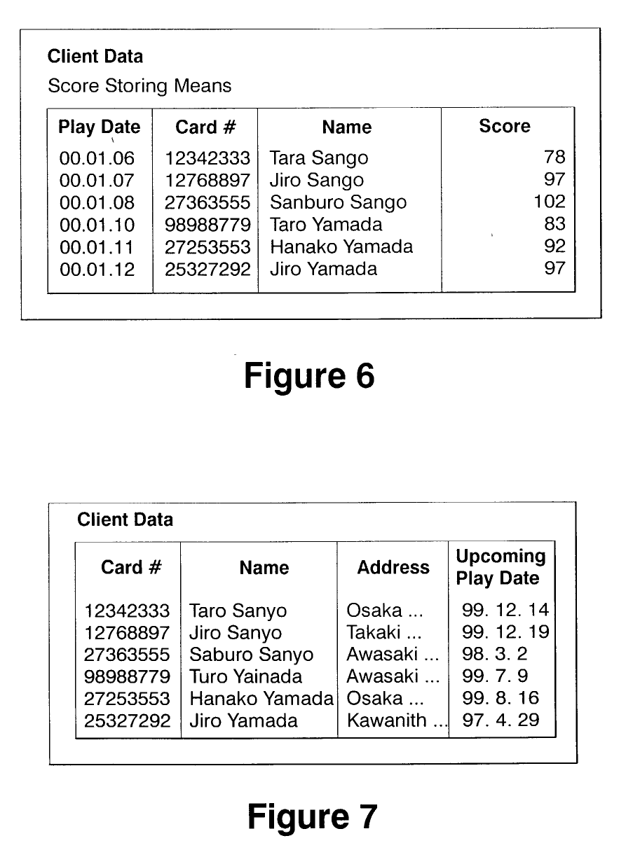

Client data 15 includes a score storing means 16, which stores the past score and play date of a player, and an address storing means 17, which stores a player's card number, name, address, and other personal information. Referring to FIG. 6, a score storing means 16 in the client data 15 stores the player's name, card number, play date, and the score for the day. FIG. 17 illustrates a sample address storing means 17 including the name of a player who made the reservation, address, card number, and upcoming play date.

Input means 18 is located at the reception counter of the golf site 1, the restaurant, and check-out sites where golf products are purchased and play fees are paid. Input means 18 receives data from credit cards and when that data is received from the input means 18, a reporting means 19, e.g., a CRT, displays messages to players.

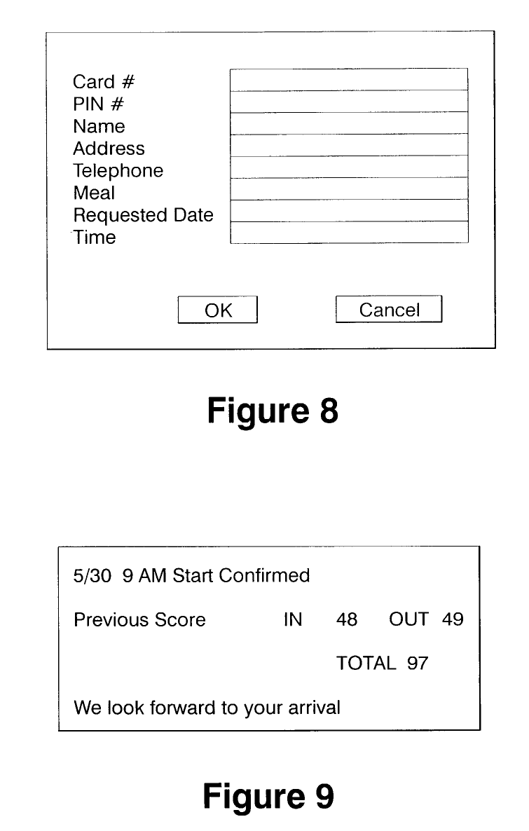

FIGS. 8 and 9, illustrate the operations of the preferred embodiment performed to register reservations for a player. Referring to FIG. 8, when a player uses the terminal 8 to make a reservation through a communication circuit, such as the Internet, the player enters a card number, a PIN number, a name, address, meal, requested play date, and requested start time. The player then presses the “OK” button to transmit the entered data to the input/output means 9 at the golf site 1. The player can cancel the entered information by pressing “Cancel”. When “OK” is pressed and the information is sent, the control circuit 10 verifies the data received by input/output means 9 against reservation storing means 11 to see if there is any overlap. Referring to FIG. 9, if there is an available reservation, input/output means 9 displays an indication that a reservation was made. The meal field on the screen displayed on the terminal 8 is referred to as food selecting means.

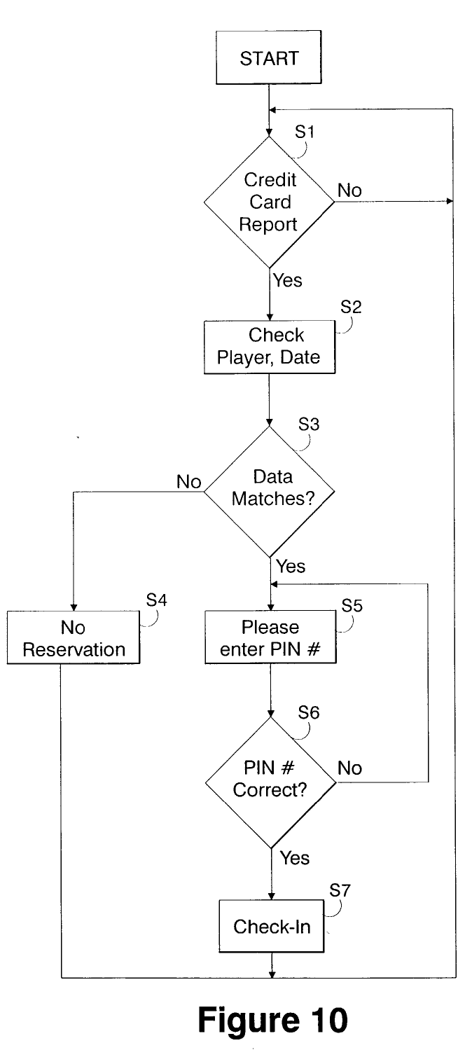

FIG. 10 is a flowchart illustrating the check-in operations performed when the player arrives at the golf site 1 and registers. When the player arrives at the golf site 1, the player's credit card is registered through input means 18 (S1), and the registered data and the schedule data 12 stored when the reservation was made are checked by the control circuit 10 (S2). After this checking operation, if a reservation was not made or if the reservation is for a different date (S3), a message indicating that no request was made is displayed on reporting means 19 (S4). If the player has a reservation, a message requesting a PIN is output to the player on the reporting means 19 (S5). The PIN is then checked (S6) and if it is correct, check-in is performed (S7). If the PIN is not correct, the player is requested to re-enter the PIN (S5).

When the player is finished playing, the credit card is used to check out, allowing the golf site 1 to recognize that play has been completed. Play fees are totaled, and this data is sent to accounting data storing means 13.

Furthermore, if drinks or other foodstuffs are purchased at a concession stand or if golf balls or other items are purchased at a store, payment is made via credit card, and this data is also stored in accounting data storage means 13.

Also, when the player checks out, the player may also enter his or her score. Data indicating that the player has checked out is sent to the schedule data 12 and data indicating that play has finished is stored. The entered score is stored in score storing means 16.

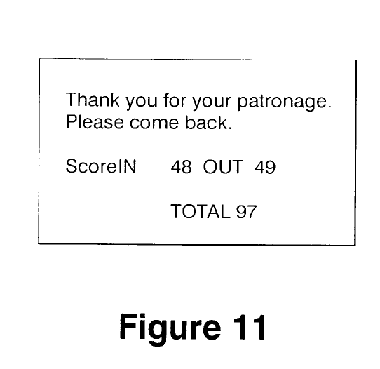

Lastly, referring to FIG. 11, a few days after play has finished, the player's address, name, and score are automatically read from the client data 15, and information thanking the customer is output on the terminal 8 by input/output means 9 via the Internet.

In the embodiment described above, the player orders food at the same time as the reservation is made. However, it will be understood by those skilled in the art that the food may be ordered when the player checks in. For this embodiment, the information can be entered using input means 18.

As described above, the player uses his/her own terminal 8 to make a reservation via the Internet. The golf site 1 can confirm and make reservations in an automated manner, thus eliminating the need to provide personnel to make reservations. Furthermore, since the player checks in to the golf site 1 using a credit card, the personnel for the check-in desk can also be eliminated.

Also, since purchases made by the player are also handled using the credit card, they can be processed automatically. Since invoices to the credit card company 6 are issued automatically, the corresponding personnel can be eliminated as well.

Furthermore, since food orders to the foodstuff company 7 are performed automatically, the corresponding personnel can be eliminated. Also, this eliminates the need for personnel to order or track the food, accurate order quantities can be sent and automatically stored. Thus, daily orders can be tracked clearly, and excess and insufficient ordering can be eliminated.

The entire process including providing the confirmation of the reservation date, thank-you messages from the golf site, and previous scores provide an added convenience to the player. Additionally, since the information is sent from the golf site to the terminal at a predetermined time after a play completed signal is received allows thank-you messages and scores to be sent a few days after play, and services, advertisements, and promotions can be provided to the player.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. A golf site administration system comprising:
a first input/output means for requesting golf play; said first input/output means connected via a communication circuit to a terminal for requesting golf play;
a reservation storing means for storing a play request signal received from said first input/output means;
a second input means allowing a player to check in before play; and
a control circuit means for comparing an input signal of said second input means with said play request signal stored in said reservation storing means; and said control circuit means performing at least a first check-in when said signals match and indicating at least a first set of information on a reporting means if said signals do not match.

2. A golf site administration system comprising:
a first input means for checking in a golf player using a credit card before play; said first input means including a means for receiving said credit card for payment of a definable set of fees within said golf site and generating an input signal;
an accounting data storing means for storing said input signal of said input means; and
a control circuit means for reading data stored in said accounting data storing means at a predetermined time and for sending said data to a credit card company using a communication circuit.

3. A golf site administration system comprising:
a food selecting means for allowing a golf player to enter a foodstuff data into an entering means;
a foodstuff data storing means for storing said foodstuff data ordered with food selecting means; and
a control circuit means for sending said foodstuff data from said foodstuff data storing means to an external foodstuff company at a predetermined time via a communication circuit.

4. A golf site administration system, as described in claim 3, wherein said food selecting means receives foodstuff data when said player requests play; and
said control circuit means sends information from said foodstuff data storing means to said external foodstuff company using said communication circuit at a predetermined time before play.

5. A golf site administration system as described in claim 1, wherein when a play request signal is received by said input/output means, an information packet from said golf site is sent to said terminal via said communication circuit.

6. A golf site administration system as described in claim 5, further comprising:
a score storing means storing a score of said player is disposed on said golf site; and said information packet sent to said terminal from said golf site is a score of said player.

7. A golf site administration system as described in claim 1, wherein information is sent from said golf site to said terminal at a predetermined time after a play completed signal is received by said input means.

8. A method of administrating a golf site, comprising the steps of:
(a) requesting a golf play at a terminal and generating a play request signal;
(b) transmitting said play request signal over a communication circuit from said terminal to a first input/output means;
(c) communicating said play request signal from said first input/output means to a reservation storing means;
(d) storing said play request on said reservation storing means;
(e) checking-in a player on a second input means at said golf site before play begins, and said second input means generating an input signal;
(f) comparing said input signal to said play request signal using a control circuit;
(g) performing a check-in procedure if said input signal and said play request signal match; and
(h) notifying said player using a reporting means if said input signal and said play request signal do not match.

9. A method of administrating a golf site, comprising the steps of:
(a) checking-in a player at said golf site using an input means, said input means reading a credit card;
(b) generating an input signal from said input means for fees generated by said player at said golf site and transmitting said input signal to an accounting data storage means;
(c) storing said input signal at said accounting data storage means;
(d) reading said input signal from said accounting data storage means at a predetermined time by a control circuit;
(e) transmitting said input signal to a credit card company using a communication circuit.

10. A method of administrating a golf site, comprising the steps of:
(a) entering a food order using a food selecting means and generating a food data;
(b) storing said food data on a foodstuff data storing means and reading said foodstuff data storage means using a control circuit;
(c) transmitting said food data from said foodstuff data storing means to a foodstuff company via a communication circuit using said control circuit, said food data is transmitted at a predetermined time interval.

11. The method of claim 10, further comprising the steps of:
requesting a golf play and a food selection at a terminal and generating said food data;
following step (b), transmitting said food data from said foodstuff data storing means to a foodstuff company via a communication circuit using said control circuit, said food data is transmitted at a predetermined time prior to said gold play.

12. The method of claim 1, further comprising the steps of:
following step (b), communicating information from said golf site to said terminal using said communication circuit.

13. The method of claim 12, further comprising the steps of:
storing a score achieved by said player on a score storing means disposed on said golf site, wherein said information communicated to said terminal is said score.

14. The method of claim 1, further comprising the steps of:
(a) generating a play completion signal using said input means when said player completes play;
(b) transmitting information from said golf site to said terminal at a predetermined time after said play completion signal is generated.
